(19) United States
(12) Patent Application Publication
(10) Pub. No.: US 2026/0312086 A1
(43) Pub. Date: Oct. 8, 2026

(54) FLUID CONNECTOR STRUCTURE AND HYDROGEN LINE FOR FUEL CELL

(71) Applicants: TOYOTA JIDOSHA KABUSHIKI KAISHA, Toyota-shi Aichi-ken (JP); NIFCO INC., Yokosuka-shi Kanagawa-ken (JP)

(72) Inventors: Naoya TSUTSUI, Nukata-gun Aichi-ken (JP); Yusuke MIYAZAWA, Yokosuka-shi Kanagawa-ken (JP)

(73) Assignees: TOYOTA JIDOSHA KABUSHIKI KAISHA, Toyota-shi Aichi-ken (JP); NIFCO INC., Yokosuka-shi Kanagawa-ken (JP)

(21) Appl. No.: 19/630,595

(22) Filed: Mar. 27, 2026

(30) Foreign Application Priority Data
Apr. 2, 2025 (JP) 2025-061220

(51) Int. Cl. H01M 8/0276; H01M 8/04082

(52) U.S. Cl. CPC H01M 8/0278; H01M 8/04201; H01M 2250/20

(57) ABSTRACT

A fluid connector structure includes: a first connection portion configured to be connectable to either an outer side or an inner side of a second connection portion; and a sealing member configured to seal between the first connection portion and the second connection portion in a connected state. The first connection portion includes a groove extending around a central axis of the first connection portion on a connection surface. The sealing member is disposed in the groove so as to be in contact with a bottom surface of the groove. The bottom surface and a contact surface of the sealing member in contact with the bottom surface each have a shape along the central axis. The sealing member includes a protruding portion. The thickness in a direction along the central axis at a tip of the protruding portion is smaller than the thickness at the contact surface.

### CROSS REFERENCE OF RELATED APPLICATIONS

The present application claims the benefit of priority to Japanese Patent Application No. 2025-61220, filed on Apr. 2, 2025, and the disclosure of which is hereby incorporated by reference in its entirety.

### BACKGROUND

### FIELD

The present disclosure relates to a fluid connector structure and a hydrogen line for a fuel cell.

### RELATED ART

Regarding a fluid connector structure, Published Japanese Translation of PCT International Publication for Patent Application No. 2023-507579 discloses a fluid connector including a connector body in which a groove is formed, and an O-ring as a sealing member disposed on the connector body

According to the technique disclosed in Published Japanese Translation of PCT International Publication for Patent Application No. 2023-507579, there is a possibility that a sealing performance for fluid in the fluid connector may be reduced since the sealing member may roll in the groove during use of the fluid connector. Therefore, there has been a demand for a technology capable of suppressing the rolling of the seal member and further improving the sealing performance for fluid in the fluid connector.

### SUMMARY

According to a first aspect of the present disclosure, fluid connector structure is provided. This fluid connector structure includes: a first connection portion having a cylindrical shape, the first connection portion configured to be connectable to either an outer side or an inner side of a second connection portion, the second connection portion having a cylindrical shape; and a sealing member having a ring shape, the sealing member configured to seal between the first connection portion and the second connection portion during a connected state in which the first connection portion and the second connection portion are connected to each other. The first connection portion includes a groove extending around a central axis of the first connection portion on a connection surface, the connection surface being one side surface of an inner surface and an outer surface of the first connection portion and being closer to the second connection portion in the connected state. The sealing member is disposed in the groove so as to be in contact with a bottom surface of the groove. The bottom surface and a contact surface of the sealing member in contact with the bottom surface each have a shape along the central axis. The sealing member includes a protruding portion protruding from the contact surface toward an opposite side of the bottom surface. A thickness in a direction along the central axis at a tip of the protruding portion is smaller than the thickness at the contact surface.

### BRIEF DESCRIPTION OF THE DRAWINGS

FIG. 1 is an explanatory diagram illustrating a schematic configuration of a fuel cell system according to a first embodiment.

FIG. 2 is a cross-sectional diagram illustrating a schematic configuration of a connector system according to the first embodiment.

FIG. 3 is an explanatory diagram for explaining a sealing member according to another embodiment.

FIG. 4 is a cross-sectional diagram illustrating a schematic configuration of a connector system according to a second embodiment.

### DETAILED DESCRIPTION

### A. First Embodiment

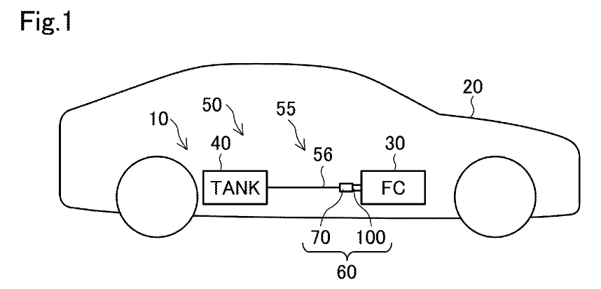

FIG. 1 is an explanatory diagram illustrating a schematic configuration of a fuel cell system 10 according to the first embodiment. In the present embodiment, the fuel cell system 10 is mounted in a vehicle 20. The fuel cell system 10 includes a fuel cell 30, a tank 40, and a hydrogen line 50. The hydrogen line 50 is a hydrogen line for fuel cell.

In the present embodiment, the fuel cell 30 is a polymer electrolyte fuel cell that generates electricity in response to a supply of anode gas containing hydrogen and cathode gas containing oxygen. The electric power generated by an electrochemical reaction in the fuel cell 30 is consumed by various loads mounted in the vehicle 20.

The tank 40 stores fuel gas used as the anode gas in the fuel cell 30 and supplies the fuel gas to the fuel cell 30. In the present embodiment, the tank 40 is configured as a high-pressure tank that stores the hydrogen gas as the fuel gas.

The hydrogen line 50 connects between the fuel cell 30 and the tank 40. The hydrogen line 50 functions as a supply line for supplying the fuel gas stored in the tank 40 to the fuel cell 30. Namely, the fuel gas stored in the tank 40 is supplied to the fuel cell 30 through the hydrogen line 50.

The hydrogen line 50 includes a piping unit 55 including a connector system 60 and a piping member 56. The connector system 60 includes a first connector 70 and a second connector 100 that are configured to be connectable to each other. The piping member 56 is configured of various flow path members, such as a hose or a pipe, and is connected to the connector system 60. A pump, a compressor, a valve, or the like for controlling a flow and a flow rate of the fuel gas in the piping unit 55 may be disposed in the piping unit 55, for example.

The piping unit 55 is configured to be able to connect between the fuel cell 30 and the tank 40. More specifically, the first connector 70 and the second connector 100 included in the connector system 60 are connected to each other, and thereby the fuel cell 30 and the tank 40 are connected to each other through the connector system 60 and the piping member 56. In the present embodiment, the second connector 100 is directly connected to a cell stack included in the fuel cell 30 without passing through the piping member 56. Namely, the piping member 56 in the present embodiment connects between the tank 40 and the connector systems 60. In an alternative embodiment, the first connector 70 may be directly connected to the fuel cell 30, for example. Alternatively, the connector system 60 does not necessarily have to be directly connected to the fuel cell 30.

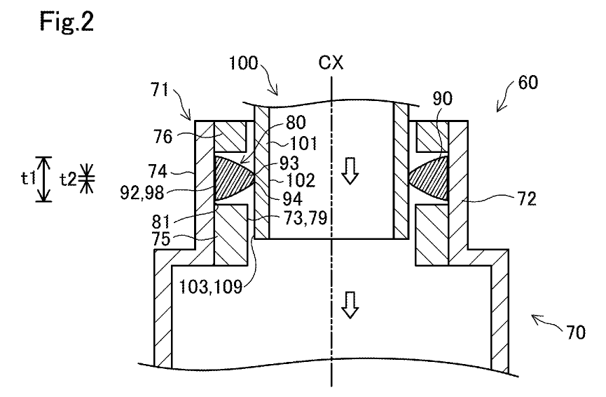

FIG. 2 is a cross-sectional diagram illustrating a schematic configuration of the connector system 60 according to the first embodiment. As illustrated in FIGS. 1 and 2, the connector system 60 includes the first connector 70 and the second connector 100. The first connector 70 and the second connector 100 are capable of allowing fluid to flow therethrough. The first connector 70 and the second connector 100 are configured to be connectable to each other. In the hydrogen line 50, the first connector 70 and the second connector 100 are used in a connected state. The connected state is in a state where a first connection portion 72 of the first connector 70 and a second connection portion 101 of the second connector 100 are connected to each other. Details of the first connection portion 72 and the second connection portion 101 will be described later. The connected state corresponds to a state where the first connector 70 and the second connector 100 are connected to each other.

The connector system 60 is configured as a quick connector. More specifically, the first connector 70 and the second connector 100 are connectable to each other without using any tools by inserting one of the first connector 70 and the second connector 100 into the other thereof. When the first connector 70 and the second connector 100 are not fixed to each other by another fixing mechanism, the connection between the first connector 70 and the second connector 100 are disconnectable from each other without using any tools by pulling one of the first connector 70 and the second connector 100 from the other. Note that, in the connector system 60, a fixing mechanism may be used to fix the first connector 70 and the second connector 100 in the connected state.

In the connector system 60, one of the first connector 70 and the second connector 100 is configured as a male connector, and the other is configured as a female connector. In the present embodiment, the first connector 70 is configured as a female connector, and the second connector 100 is configured as a male connector. As a result, the first connection portion 72 of the first connector 70 is configured to be connectable to an outer side of the second connection portion 101, as will be described later. Namely, in the connection state, the first connection portion 72 is disposed on the outer side of the second connection portion 101.

In an alternative embodiment, the first connector 70 may be configured as a male connector, and the second connector 100 may be configured as a female connector. In this embodiment, the first connection portion of the first connector 70 is configured to be connectable to an inner side of the second connection portion. Namely, in this embodiment, the first connection portion 72 is disposed on the inner side of the second connection portion 101, in the connection state.

In the present embodiment, the first connection portion 72 is disposed downstream of the second connection portion 101, that is, on the fuel cell 30 side, in the hydrogen line 50. In an alternative embodiment, the first connection portion 72 may be disposed upstream of the second connection portion 101, regardless of whether the first connection portion 72 is configured as the female connector. In FIG. 2, a flow of fluid inside the first connection portion 72 and the second connection portion 101 is schematically indicated by white arrows.

As illustrated in FIG. 2, the first connector 70 includes a fluid connector structure 71. The fluid connector structure 71 includes the above-described first connection portion 72 and a sealing member 90. The second connector 100 includes the above-described second connection portion 101. In the present embodiment, the fluid connector structure 71 is used to flow hydrogen between the first connection portion 72 and the second connection portion 101 while sealing the hydrogen as the fluid hermetically by the sealing member 90.

The first connection portion 72 has a hollow cylindrical shape. In the present embodiment, the first connection portion 72 has a cylindrical shape. A groove 80 is formed in the first connection portion 72. In the present embodiment, the groove 80 is formed on a first inner surface 73. The first inner surface 73 is an inner surface of the first connection portion 72. In the following description, an outer surface of the first connection portion 72 is also referred to as a first outer surface 74.

The groove 80 extends around a central axis CX of the first connection portion 72. More specifically, the groove 80 is formed around the central axis CX of the first connection portion 72 so as to go around the first inner surface 73. In the present embodiment, the groove 80 opens inward toward the central axis CX. A bottom surface 81 of the groove 80 has a shape along the central axis CX. More specifically, the bottom surface 81 is a band-shaped surface, which extends around the central axis CX and is flat in a direction of the central axis CX. The bottom surface 81 is a flat surface along the central axis CX direction and a circumferential direction of the bottom surface 81 when being developed in the circumferential direction. As a result, as illustrated in FIG. 2, when the groove 80 is viewed in cross section along a cutting surface including the central axis CX, the bottom surface 81 has a shape like a line segment along the central axis CX.

The groove 80 disclosed in the present embodiment is partitioned by a ring-shaped first ring member 75 and a ring-shaped second ring member 76. The first ring member 75 and the second ring member 76 are disposed to be spaced apart from each other in a direction of the central axis CX, on the inner side of the first connection portion 72. As a result, the groove 80 is partitioned between the first ring member 75 and the second ring member 76.

The second connection portion 101 has a hollow cylindrical shape. In the present embodiment, the second connection portion 101 has a cylindrical shape. An inner surface of the second connection portion 101 is also referred to as a second inner surface 102. An outer surface of the second connection portion 101 is also referred to as a second outer surface 103.

In the present embodiment, the first inner surface 73 corresponds to a connection surface 79 in the present disclosure. The connection surface 79 refers to a side surface of the outer surface or inner surface of the first connection portion 72 that is closer to the second connection portion 101 in the connected state. In the following description, a side surface of the outer surface or inner surface of the second connection portion 101 that is closer to the connection surface 79 in the connected state is also be referred to as an opposing surface 109. In the present embodiment, the second outer surface 103 corresponds to the opposing surface 109.

The sealing member 90 has a ring shape. More specifically, the sealing member 90 is configured as an elastic O-ring. The sealing member 90 is formed, for example, an elastic material, such as rubber or elastomer. It is to be noted that, in the present disclosure, the “O-ring” includes not only those having a circular cross-sectional shape but also those having a cross-sectional shape other than a circular shape. As will be described later, the sealing member 90 in the present embodiment has a D-shaped cross-sectional shape. The O-ring having such a D-shaped cross-sectional shape is also specifically referred to as "D-ring".

The sealing member 90 is disposed in the groove 80 so as to be in contact with the bottom surface 81 of the groove 80. In the connected state, the sealing member 90 is located between the first connection portion 72 and the second connection portion 101 to seal between the first connection portion 72 and the second connection portion 101. In the connected state, the sealing member 90 is disposed so as to surround a periphery of the second connection portion 101 disposed inside the first connection portion 72.

In the present embodiment, an outer sealing surface 92 of the sealing member 90 corresponds to a "contact surface 98" in the present disclosure. The contact surface 98 is a surface in contact with the bottom surface 81 of the sealing members 90. The contact surface 98 has a shape along the central axis CX, in the same manner as the bottom surface 81. More specifically, the contact surface 98 is a band-shaped surface. The contact surface 98 extends around the central axis CX and is flat in a direction of the central axis CX. The contact surface 98 is a flat surface along the central axis CX direction and a circumferential direction of the contact surface 98 when being developed in the circumferential direction. As a result, as illustrated in FIG. 2, when the sealing member 90 is viewed in cross section along a cutting surface including the central axis CX, the contact surface 98 has a shape like a line segment along the central axis CX. Even when the sealing member 90 is not disposed in the groove 80, the contact surface 98 has a shape along the central axis CX in the same manner as described above.

The sealing member 90 includes a protruding portion 93. The protruding portion 93 is a portion protruding from the contact surface 98 toward an opposite side of the bottom surface 81. A direction in which the protruding portion 93 protrudes is also referred to as a protruding direction. The protruding direction in the present embodiment is a direction from an outer side to an inner side of the sealing member 90. A thickness t2 at a tip 94 of the protruding portion 93 in the protruding direction is smaller than a thickness t1 of the contact surface 98. The "thickness" used herein means a thickness in the central axis CX direction. In the present embodiment, the sealing member 90 includes one protruding portion 93. In the present embodiment, the protruding portion 93 has a tapered shape in which the thickness gradually decreases in the protruding direction. In the present embodiment, the tip 94 has a rounded curved surface shape. As a result, as illustrated in FIG. 2, when the sealing member 90 is viewed in cross section along a cutting surface including the central axis CX, the sealing member 90 has the above-described D-shape. In an alternative embodiment, the tip 94 may have, for example, a sharply pointed shape. Alternatively, the protruding portion 93 may not have a tapered shape and may have, for example, a shape in which the thickness decreases step by step in the protruding direction.

In the present embodiment, a dimension of the sealing member 90 in the central axis CX direction is smaller than a width of an opening of the groove 80 in the central axis CX direction. In such a way, it is possible to dispose the sealing member 90 in the groove 80 without compressing the sealing member 90 in the central axis CX direction during a disposing process for disposing the sealing member 90 in the groove 80. As a result, it is possible to prevent the sealing performance of the sealing member 90 from being reduced due to deformation of the sealing member 90 caused by compression of the sealing member 90 inside the groove 80.

With the sealing member 90, the connector system 60 exhibits a function as the above-described quick connector. Moreover, with the sealing member 90, the connector system 60 exhibits a clearance function in the hydrogen line 50. The clearance function is a function to ensure room for arrangement of various parts in the hydrogen line 50. More specifically, the sealing member 90 seals between the first connection portion 72 and the second connection portion 101 while allowing for minute relative positional and angular misalignments between the first connection portion 72 and the second connection portion 101, thereby realizing the clearance function of the connector system 60. Since the connector system 60 has a clearance function, the connector system 60 is capable of absorbing dimensional tolerances even if such dimensional tolerances of various parts in the hydrogen line 50 are accumulated, for example. As a result, it is possible to configure the hydrogen line 50 and the fuel cell system 10 more compact while ensuring ease of manufacturing the hydrogen line 50 and the fuel cell system 10.

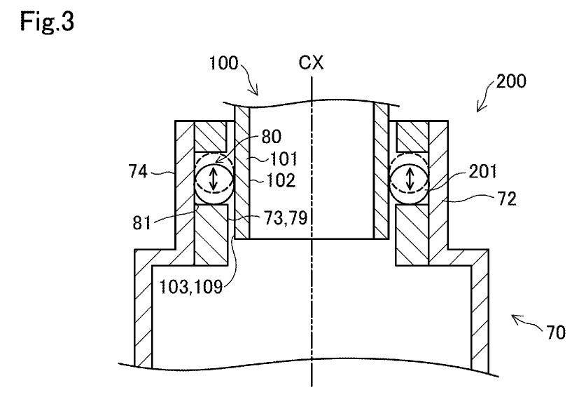

FIG. 3 is an explanatory diagram for explaining a sealing member 201 in a connector system 200 as another embodiment. It is to be noted that FIG. 3 omits cross section hatching of the sealing member 201 to facilitate understanding of the technology. The sealing member 201 is configured as a conventional O-ring in which its cross-sectional shape has a circular shape, in contrast to the sealing member 90 in the present embodiment. In the example of FIG. 3, due to the circular cross-sectional shape of the sealing member 201, during use of the connector system 200, a portion or all of the sealing member 201 in the circumferential direction may move along the central axis CX by rolling on the connection surface 79. In FIG. 3, such rolling of the sealing members 90 is schematically illustrated by the arrows and dashed lines. The rolling of the sealing member 90 may cause gaps due to twisting of the sealing member 90 or may cause fluid to be drawn into the sealing member 90, potentially reducing the sealing performance of the sealing member 90. It is to be noted that the "drawn into" used herein means that gas adhering to the sealing member 90 leaks out from the sealing portion formed by the sealing member 90 as the sealing member 90 rolls.

In contrast, in the present embodiment, since the contact surface 98 of the sealing member 90 has a shape along the direction of the central axis CX, like the bottom surface 81 of the groove 80, it is possible to bring the contact surface 98 and the bottom surface 81 into closer contact with each other, thereby suppressing the sealing member 90 from rolling inside the groove 80. Moreover, since the thickness t2 at the tip 94 of the protruding portion 93 is smaller than the thickness t1 of the contact surface 98, it is possible to further reduce a contact area between the tip 94 and the opposing surface 109, for example, when the first connection portion 72 and the second connection portion 101 are connected to each other, thereby ensuring the smooth connection between the first connection portion 72 and the second connection portion 101. As a result, it is possible to suppress deformation of the sealing member 90 caused by the connection between the first connection portion 72 and the second connection portion 101. Thus, in accordance with the fluid connector structure 71 disclosed in the present embodiment, it is possible to further improve the sealing performance of fluid in the fluid connector structure 71.

In the present embodiment, the hydrogen line 50 for the fuel cell 30 includes the connector system 60 as the quick connector. Conventionally, it has been avoided that quick connectors using such a sealing member 90 as an O-ring are adopted into piping components for flowing hydrogen gas. This is because hydrogen gas is particularly prone to leaking, and the permissible limit for hydrogen gas leakage is generally relatively low. Particularly, it has been avoided that the quick connectors are adopted as piping components of the hydrogen line 50 for fuel cells where high-pressure hydrogen is handled. In contrast, in the present embodiment, the connector system 60 is applicable to the hydrogen line 50 where such high-pressure hydrogen gas is handled since the sealing performance is further improved by suppressing rolling and deformation of the sealing member 90, in the connector system 60.

In the present embodiment, the connector system 60 is directly connected to the fuel cell 30. Therefore, since the clearance function of the connector system 60 is capable of effectively absorbing the dimensional tolerance of the piping member 56 near the fuel cell 30, it is possible to reduce a clearance space taking into account the dimensional tolerance of the piping member 56. As a result, it is possible to configure, in an even more compact manner, the vicinity of the fuel cell 30, which tends to be crowded due to the arrangement of an oxygen line, a cooling water line, drainage and exhaust lines, and the like in addition to the hydrogen line 50. In addition, such an effect is not limited to the configuration in which the second connector 100 is directly connected to the fuel cell 30 as in the present embodiment, but is also produced in the configuration in which the first connector 70 is directly connected to the fuel cell 30.

### B. Second Embodiment

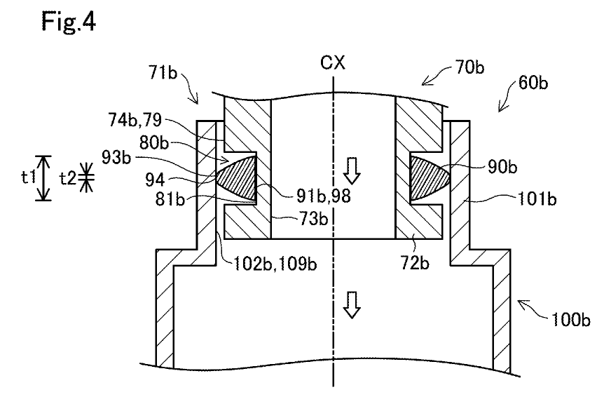

FIG. 4 is a cross-sectional diagram illustrating a schematic configuration of a connector system 60b in the second embodiment. In the present embodiment, in contrast to the first embodiment, a first connector 70b is configured a male connector, and a second connector 100b is configured as a female connector. As a result, in the present embodiment, a first connection portion 72b is configured to be connectable to an inner side of a second connection portion 101b. Moreover, in the connected state, the first connection portion 72b is disposed on the inner side of the second connection portion 101b. The configurations of the fuel cell system 10, the connector system 60b, and a fluid connector structure 71b in the second embodiment are the same as those in the first embodiment for the points not specifically described.

In the present embodiment, not a first inner surface 73b but a first outer surface 74b of the first connection portion 72b correspond to the connection surface 79. Therefore, in the present embodiment, a groove 80b is formed on the first outer surface 74b. Moreover, in the present embodiment, a second inner surface 102b corresponds to the opposing surface 109. In the present embodiment, an inner sealing surface 91b of a sealing member 90b corresponds to the contact surface 98 and has a shape along the central axis CX direction in the same manner as a bottom surface 81b of the groove 80b. Moreover, a protruding direction of a protruding portion 93b in the present embodiment is a direction from an inner side to an outer side of the sealing member 90b.

The fluid connector structure 71b in the second embodiment described above is also capable of suppressing the sealing member 90b from rolling inside the groove 80b, and ensuring smooth connection between the first connection portion 72b and the second connection portion 101b, thereby further improving the fluid sealing performance of the fluid connector structure 71b.

### C. Alternative embodiments

(C1) According to each of the above-described embodiments, the sealing member 90 has a single protruding portion 93. Not limited to this example, the sealing member 90 may have two or more protruding portions 93.

(C2) In each of the above embodiments, the fluid connector structure 71 is not limited to being used in the hydrogen line 50, but may also be used in various piping lines for flowing various fluids. In the fluid connector structure 71, the fluid is not limited to fuel gas, and various gases and liquids may be used, for example.

The disclosure is not limited to any of the embodiment and its modifications described above but may be implemented by a diversity of configurations without departing from the scope of the disclosure. For example, the technical features of any of the above embodiments and their modifications may be replaced or combined appropriately, in order to solve part or all of the problems described above or in order to achieve part or all of the effects described above. Any of the technical features may be omitted appropriately unless the technical feature is described as necessary in the description hereof. The present disclosure may be implemented by aspects described below.

(1) According to a first aspect of the present disclosure, fluid connector structure is provided. This fluid connector structure includes: a first connection portion having a cylindrical shape, the first connection portion configured to be connectable to either an outer side or an inner side of a second connection portion, the second connection portion having a cylindrical shape; and a sealing member having a ring shape, the sealing member configured to seal between the first connection portion and the second connection portion during a connected state in which the first connection portion and the second connection portion are connected to each other. The first connection portion includes a groove extending around a central axis of the first connection portion on a connection surface, the connection surface being one side surface of an inner surface and an outer surface of the first connection portion and being closer to the second connection portion in the connected state. The sealing member is disposed in the groove so as to be in contact with a bottom surface of the groove. The bottom surface and a contact surface of the sealing member in contact with the bottom surface each have a shape along the central axis. The sealing member includes a protruding portion protruding from the contact surface toward an opposite side of the bottom surface. A thickness in a direction along the central axis at a tip of the protruding portion is smaller than the thickness at the contact surface.

According to this aspect, the bottom surface of the groove and the contact surface of the sealing member each have a shape along the central axis direction, thereby making it possible to suppress the sealing member from rolling inside the groove. Moreover, the thickness at the tip of the protruding portion of the sealing member is smaller than the thickness at the contact surface, thereby making it possible to ensure the smooth connection between the first connection portion and the second connection portion and to suppress deformation of the sealing member caused by the connection between the first connection portion and the second connection portion. As a result, it is possible to further improve the sealing performance of fluid in the fluid connector structure.

(2) In the above-described aspect, the first connection portion may be configured to be connectable to the outer side of the second connection portion, the connection surface may be the inner surface of the first connection portion, the contact surface may be an outer surface of the sealing member, and the contact surface may be an inner surface of the sealing member.

(3) In accordance with a second aspect of the present disclosure, a hydrogen line for a fuel cell is provided. This hydrogen line includes a connector system including a first connector having the fluid connector structure described in the above-described aspect and a second connector having the second connection portion. The hydrogen gas to be supplied to the fuel cell flows through the first connection portion and the second connection portion. According to this aspect, since rolling and deformation of the sealing member are suppressed, it is possible to apply the connector system having a further improved sealing performance to the hydrogen line for fuel cell where the hydrogen gas is handled.

(4) The above-described aspect further includes a piping member connecting between a tank and the connector system, the tank storing the hydrogen gas, wherein the connector system may be directly connected to the fuel cell. According to this aspect, since the connector system is capable of effectively absorbing the dimensional tolerance of the piping member near the fuel cell, it is possible to reduce a clearance space taking into account the dimensional tolerance of the piping member. As a result, it is possible to configure, in an even more compact manner, the vicinity of the fuel cell, which tends to be crowded due to the arrangement of an oxygen line, a cooling water line, drainage and exhaust lines, and the like in addition to the hydrogen line.

This disclosure may be realized not only in the aspect of the above-described fluid connector structure and the hydrogen line for fuel cell, but also in other aspects such as a connector system, a piping system for fluid, and the like.

What is claimed is:

1. A fluid connector structure comprising:
a first connection portion having a cylindrical shape, the first connection portion configured to be connectable to either an outer side or an inner side of a second connection portion, the second connection portion having a cylindrical shape; and
a sealing member having a ring shape, the sealing member configured to seal between the first connection portion and the second connection portion in a connected state where the first connection portion and the second connection portion are connected to each other, wherein
the first connection portion includes a groove extending around a central axis of the first connection portion on a connection surface, the connection surface being one side surface of an inner surface and an outer surface of the first connection portion and being closer to the second connection portion in the connected state,
the sealing member is disposed in the groove so as to be in contact with a bottom surface of the groove,
the bottom surface and a contact surface of the sealing member in contact with the bottom surface each have a shape along the central axis,
the sealing member includes a protruding portion protruding from the contact surface toward an opposite side of the bottom surface, and
a thickness in a direction along the central axis at a tip of the protruding portion is smaller than the thickness at the contact surface.

2. The fluid connector structure according to claim 1, wherein
the first connection portion is configured to be connectable to the outer side of the second connection portion,
the connection surface is the inner surface of the first connection portion, and
the contact surface is an outer surface of the sealing member.

3. A hydrogen line for a fuel cell comprising a connector system including a first connector having the fluid connector structure according to claim 1 and a second connector having the second connection portion, wherein
hydrogen gas to be supplied to the fuel cell flows through the first connection portion and the second connection portion.

4. The hydrogen line according to claim 3, further comprising
a piping member connecting between a tank and the connector system, the tank storing the hydrogen gas, wherein
the connector system is directly connected to the fuel cell.
